(19) United States
(12) Patent Application Publication
(10) Pub. No.: US 2019/0286097 A1
(43) Pub. Date: Sep. 19, 2019

(54) METHOD FOR ERROR DETECTION AND INSTALLATION FOR MACHINING A WORKPIECE

(71) Applicant: HOMAG GmbH, Schopfloch (DE)

(72) Inventors: Stefan ROTHFUSS, Baiersbronn (DE); Michael ZETZSCHE, Albstadt (DE); Heiko STRAUB, Rottenburg a. N. (DE)

(21) Appl. No.: 16/352,760

(22) Filed: Mar. 13, 2019

(30) Foreign Application Priority Data
Mar. 15, 2018 (DE) 10 2018 203 976.3

(51) Int. Cl. G05B 19/406

(52) U.S. Cl. CPC G05B 19/406; G05B 2219/50058; G05B 2219/37234

(57) ABSTRACT

Method for error detection and for local limitation of a cause of the error in an installation for machining a workpiece which is preferably formed at least in sections from wood, a wood material, and/or a synthetic material, the installation having several segments, comprising the steps: Detecting a workpiece parameter in at least two segments of the installation; determining whether there is an error on the basis of the detected workpiece parameter; if there is an error, identifying in which of the at least two segments of the installation the error is present for local limitation of the cause of the error; and outputting a signal containing the information regarding which segment the error is in.

The present invention relates to a method for error detection and for local limitation of a cause of the error in an installation for machining a workpiece which is preferably formed at least in sections from wood, a wood material, and/or a synthetic material. The present invention further relates to the use of such a method, a data carrier upon which a program is stored that is suited to performing the method, a sensor equipment set for an installation for machining a workpiece, and an installation for machining a workpiece.

Installations for machining a workpiece with conveyor belts upon which workpieces are conveyed are often operated with a high through-put speed. For example, in an industrial edging installation for wood workpieces in which the latter are provided with a solid wood edge or a paper edge—as they are used in furniture manufacturing—between 8000 and 12000 workpieces are processed per day in some cases.

Experience shows that in such high-performance installations, a performance loss can occur, the cause of which is not easy to establish. Sometimes such a performance loss also occurs gradually, so that the number of machined workpieces per day slowly decreases and the decrease is not immediately recognized. If the performance then drops noticeably at some time (by 10 or 20 percent, for example), it is therefore certain that there is an error in the installation—for example, a fault in a conveyor belt or a machine—however, it is unclear where the error comes from. Moreover, such an appreciable drop in performance as such is not desirable, however, earlier intervention may not be feasible for economic reasons.

The error detection therefore often occurs late after a gradual performance loss has already continued over a certain time period until a perceivable drop in the performance of the installation becomes noticeable. Since the workpiece machining installations are, as a rule, complexly structured and are equipped with several machining aggregates (for example, a sawing aggregate, a drilling aggregate, a gluing aggregate, a pressing aggregate, a welding aggregate, etc.) as well as conveyor belt sections lying in between, identifying the cause of an error following the detection of an error can be time-consuming. Sometimes it is also necessary to interrupt production in an installation in order to carry out further investigations into various aggregates and at various conveyor belt sections in order to determine whether the aggregates or conveyor belt sections concerned have an error (fault).

It is disadvantageous that an error detection is often only possible at a late stage. Furthermore, it is disadvantageous that a gradual performance loss cannot be detected earlier and that a noticeable drop in the performance of the installation must first occur as a prerequisite for a detection or an intervention by switching off the installation and investigating. Moreover, it is also disadvantageous that considerable production losses can result from downtimes.

Consequently, it is an object of the present invention to deal with one or more of the described disadvantages of known workpiece machining installations.

### Introductory Part of the Description

One aspect of the present invention relates to a method for error detection and for local limitation of a cause of the error in an installation for machining a workpiece which is preferably formed at least in sections from wood, a wood material, and/or a synthetic material, with the installation having several segments. The method comprises the steps: Detecting a workpiece parameter which relates to a workpiece throughflow in at least two segments of the installation; determining whether there is an error on the basis of the detected workpiece parameter; if there is an error, identifying in which of the at least two segments of the installation the error is present for local limitation of the cause of the error; and outputting a signal containing the information regarding which segment the error is in.

Preferably, it is determined whether a future performance loss of the installation is to be expected, and that there is an error if a future performance loss is expected. In this way, an error is already proactively identified (i.e., it is concluded that there is an error) if a performance loss has not even actually occurred, but rather already then if a performance loss is expected in the future (a future performance loss). In some embodiments, the performance loss is defined by the fact that a quantity of workpieces processed by the installation during a predetermined time unit falls below a predetermined threshold value. In other embodiments, the performance loss is defined as another parameter quantifying the performance of the installation or, for example, as a falling beneath a predetermined threshold value of such a parameter. In some embodiments, a performance loss is defined as the falling of such a parameter outside of a predetermined value range.

The predetermined time unit can be, for example, a minute, an hour, or a day (or another suitable unit of time). In some embodiments, a user can also predetermine or adjust the time unit itself. Thus, for example, a performance loss can be defined as the installation processing fewer than 8500 workpieces per day, etc. Preferably, the threshold value in the wood processing (in particular edge processing) is defined in a range from 7000 to 10000 workpieces per day (or an equivalent parameter).

It is preferably determined that there is an error, before the performance loss actually occurs. This means that an error is already then detected when a performance loss would only become noticeable gradually or when a performance loss is even about to occur, i.e. before an actual performance loss occurs. Before the number of pieces processed decreases, it can be detected, for example, that a reduction in the number of pieces is to be expected in the near future. On the basis of this information, proactive action can then be taken. For example, a maintenance time can be brought forward, or specific attention can be paid during a routine maintenance to the segment of the installation identified as having a fault, etc. Thus, an actual performance loss can be prevented. Often this can even be prevented, often at least weakened.

In some embodiments, the error is determined on the basis of a temporal development of detected status information. In this way, for example, tendencies can be identified at an early stage and consequently a gradual performance loss can be prevented.

The installation can have two or more segments, and in some embodiments, a workpiece parameter is not detected in all (for example, only in two) segments. In other embodiments, a workpiece parameter is detected in each segment. The division into segments can be thereby strongly compartmentalized—i.e., for example, such that each machining aggregate of the installation is positioned in a different segment or even such that one aggregate is assigned to several segments and such that different conveyor belt sections are assigned to different segments—or the division can be rough—i.e. for example, several aggregates in one segment, etc.

The workpiece parameter detected in different segments can be the same workpiece parameter or a different workpiece parameter.

For example, a detected workpiece parameter can be a geometric size, a material property, a number of workpieces, a number of workpieces per time unit, scraper blade swarf, (loose) edge band, cover layer projection, a cupping of a workpiece, a groove, a bore, a breakout, a decor and/or a reflectance of a surface, a length, height and/or thickness.

Since a gradual performance loss can have an effect on the quality of the workpieces, a workpiece parameter is a particularly suitable parameter for the early detection of a performance loss or an error (fault) in the installation. If a drop in performance occurs and losses of quality occur in the workpieces, a workpiece parameter to be detected may therefore change.

Since a workpiece parameter is detected in at least two segments, it is possible, if an error occurs, to identify (in all probability) in which segment of the installation an error or fault is present. Since a signal is additionally output, which displays to a person in which segment the error is occurring, the cause of the error can be efficiently limited. This is advantageous since further clarifications can be carried out location-specifically in the installation. One possibility, for example, is to temporarily switch off and examine only one part (for example, the segment having the detected error). Other parts of the installation can still be operated. In this manner, production losses can be reduced or even eliminated.

The signal can be output centrally or de-centrally. For example, a respective error signal can be output at the respective segment. Alternatively, signals for all segments can be output to a computer and/or a controller. Some or all segments in which a workpiece parameter is detected can also transmit information to a different processing element, and a different element then outputs a signal.

According to some preferred embodiments, the method is used with an installation which has two or more aggregates for machining or inspecting workpieces, with at least two aggregates being assigned to different segments. In this way, the cause of the error can be limited to specific aggregates. According to some embodiments, with a plurality of (for example, all) aggregates, a workpiece parameter is detected and errors are searched for. This makes the error detection and cause limitation especially efficient.

According to some preferred embodiments, the identifying includes that the error is assigned to a specific aggregate or a specific part of the installation between two aggregates, and the signal that is output includes information regarding which aggregate or which part of the installation between two aggregates is faulty. A part between two aggregates or several parts between aggregates can be conveyor belt sections or can have one or more conveyor belt sections. The cause limitation for errors is especially specific in these embodiments.

According to some preferred embodiments, at least one of the detected workpieces parameters is a distance from a sensor to a workpiece and/or a thickness, a height, a length or width of the workpiece. For example, to detect a distance, a laser sensor can be used, for example, having a range of one millimeter to one meter, for example up to 130 mm. Particularly advantageous is the use of a laser sensor above the workpiece with which a first distance d1 to the workpiece is measured and of a further laser sensor below the workpiece with which a second distance d1 to the workpiece is measured. Thus, for example, a workpiece thickness can be detected in a simple manner if the distance dsum between the two sensors is known (and these are correspondingly oriented in order to measure perpendicular to the workpiece conveying plane). The workpiece thickness d corresponds to the difference of the distance and the measured distances d=dsum−(d1+d2).

According to some preferred embodiments, it is checked whether a workpiece has an undesired bend by measuring distances from one sensor or several sensors to at least two different positions of the workpiece, and for each of the measured distances it is determined whether the respective distance is below or above a lower or upper threshold value, or it is determined whether the sum of the distances or a different parameter which is a function of the distances is below or above a lower or upper threshold value. For example, laser sensors are also used in this case.

According to some preferred embodiments, it is checked whether the detected workpiece parameter or a parameter which is a function of the detected workpiece parameter or the detected workpiece parameters is within a predetermined tolerance range. If one or more workpiece parameters or a function thereof lies outside of the tolerance range, the presence of an error is concluded in some embodiments. In further embodiments, the presence of an error is additionally or alternatively concluded if the tolerance range is left during a predetermined period of time or with a certain number of repetitions (with, and in other embodiments, without interruptions). For example, in some embodiments, the presence of an error is concluded if a tolerance range has been consistently left during five minutes, or if 50% of the workpieces have left the tolerance range for more than 20 minutes, etc.

According to some preferred embodiments, it is counted how often the same error occurs and it is determined whether the number of the same error exceeds a predetermined threshold value, and an error message is output if the threshold value is exceeded. In this way, gradual performance losses can be detected in an especially efficient manner and/or at an early stage.

Detected workpiece parameters can be compared from several segments. It is also provided in embodiments that a several workpiece parameters are detected in one segment or the same workpiece parameters are detected at several locations within the same segment.

According to some preferred embodiments, an error is detected from a tendency of detected values of a workpiece parameter or from tendencies of several detected workpiece parameters. In this manner, an especially proactive, early error detection can be performed. In particular, gradual performance losses can be recognized especially early, even then if these are not yet reflected in a loss of production. If, for example, the average thickness of workpieces increases or decreases by a certain amount each day, an aggregate which is (also) responsible for the thickness (for example, a sawing aggregate or a grinding aggregate, etc.) can be examined at an early stage (for example, during a regular downtime of the installation) and, if necessary, maintained correspondingly. Conveyor belt sections can also be dealt with correspondingly.

One further aspect of the present invention lies in the use of the method according any one of the above-described embodiments (or a combination of different embodiments) in an edging installation for machining an edge of a workpiece and/or for applying an edge element to a workpiece. In such an edging installation, an early error detection and a limitation of the cause of the error is particularly advantageous since large cycle times (for example, 8000-12000 workpieces per day) are reached, and consequently, an additional downtime leads to a perceivable performance loss.

According to some embodiments, a diagonal of a surface of a workpiece is calculated or measured, preferably of the largest workpiece surface, and a tolerance value is set to a value in the range of 0.1% to 1% of the diagonal, with it being checked whether a thickness and/or a flatness of at least one part of the workpiece does not deviate by more than the tolerance value from a predetermined target value, and with the tolerance value preferably being set to a value between 300 μm and 2.5 mm. For wood processing installations, these numerical ranges or values allow particularly efficient error detection.

The invention also relates to a data carrier on which a program is stored which is suited to being executed on a data processing system which can be operated together with an installation for machining a workpiece which is preferably formed at least in sections from wood, a wood material and/or a synthetic material, so that the method is carried out in accordance with one of the preceding embodiments. Thus, an existing controller of an installation can be equipped with the program, so that the controller can contribute to the performance of the method.

The invention also relates to a sensor equipment set for equipping an installation for machining a workpiece which is preferably formed at least in sections from wood, a wood material, and/or a synthetic material, with a sensor system for setting up the installation to perform a method for detecting an error and for local limitation of an error, with the sensor system having a plurality of sensors suited to detecting a workpiece parameter.

With the sensor equipment set, an installation which is not suited to performing the method according to one of the previously described aspects or one or several of the described embodiments can be retrofitted so that the method can be performed. It can therefore be avoided that installations need to be completely replaced in order to achieve better performance over a long period of time. This is particularly advantageous since sensors that are already present in installations are not generally optimally positioned or are even completely unsuited to detecting workpiece parameters and the sensor type is often also not suited for this in existing installations. On the other hand, the sensor equipment set can be provided with sensors of the type or those types which are optimal for the planned detection of workpiece parameters (for example, laser sensors), and the sensors can be applied to locations at which a workpiece parameter is supposed to be detected. For example, in one or more segments, a sensor can be arranged above and/or below the conveyor belt, and one or more sensors can be arranged at one or more aggregates (or any, if desired).

According to some preferred embodiments, the sensor equipment set has at least one sensor unit having at least one of the sensors of the set, with the sensor unit being configured to transmit a signal to a receiver via a cable connection or wirelessly. The part of the unit which is configured to send data can thereby be formed integrally with the sensor or as a separate component, or as separate components.

Several preferred embodiments of the sensor equipment set or the sensor retrofitting set further have a previously-described data carrier. Consequently, the sensor retrofitting set can be used to equip an installation with the sensors necessary for detecting desired workpiece parameters as well as to enable a data processing system to work together with the installation and the sensors in order to operate the method according to the invention or a further development thereof in the operating installation.

One aspect of the invention relates to an installation for machining a workpiece which is preferably formed at least in sections from wood, a wood material, and/or a synthetic material, with the installation having several segments and each segment having at least one sensor for detecting a workpiece parameter. The installation further has a controller that is configured to perform the method according to one of the previously described aspects.

The invention is not restricted to installations in which each segment has a corresponding sensor, but rather also includes installations in which one or more segments do not have a sensor. Alternatively, the segmentation can be correspondingly redefined such that each of the “new” segments has a sensor (in some cases only two segments are then still present after the definition of the segments has been adapted).

According to several embodiments, the installation is provided with a sensor equipment set according to one of the above-described aspects.

### BRIEF DESCRIPTION OF THE FIGURES

In the following, preferred embodiments of the present invention will be described with reference to the figures.

FIG. 1 is a schematic view of an installation for machining a workpiece.

FIG. 1 is a schematic view of an installation 100 for machining a workpiece w that is formed at least in sections from wood or a wood material. Specifically, the shown installation 100 is an edging installation for applying solid wood edges or paper edges to wooden workpieces or wood material workpieces.

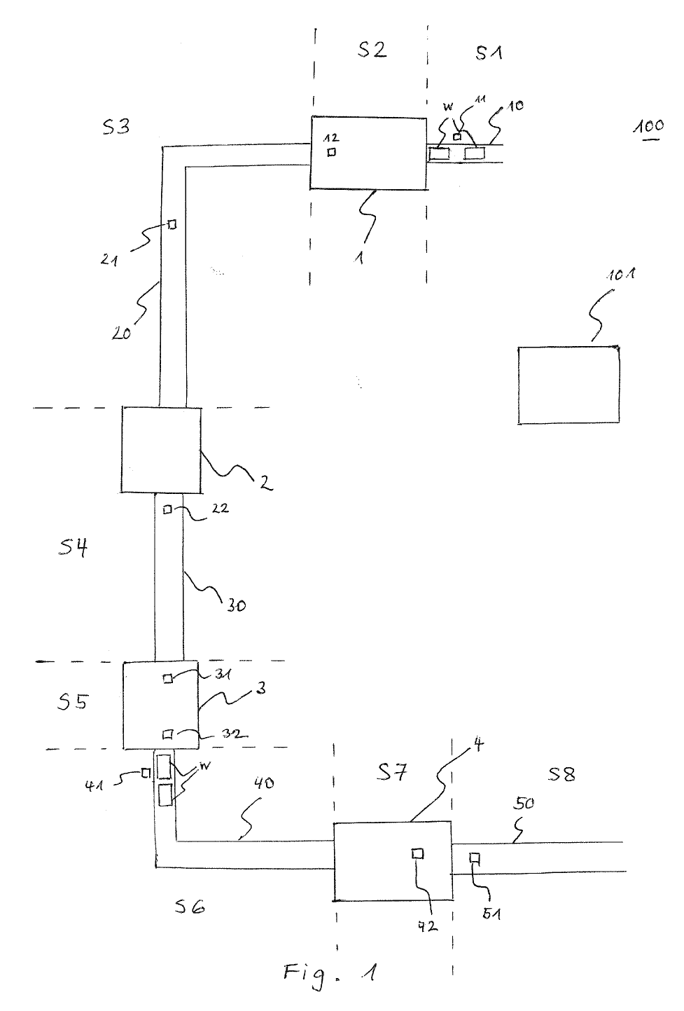

To perform a method for detecting an error and for local limitation of a cause of the error in the installation 100, the installation 100 is divided into segments. In some embodiments, the total number of segments is two, in other embodiments, the number is higher, sometimes even significantly higher. The installation of FIG. 1, for example, is divided into eight segments, S1 to S8.

The installation 100 furthermore has four machining aggregates 1, 2, 3, 4, for machining. Other embodiments can have a diverging number of machining aggregates. Moreover, installations in which the method is performed can also have inspection aggregates and/or aggregates which carry out one or more machining functions and/or inspection functions. One example for an aggregate is an edge coating aggregate that applies an edge to a wood workpiece, for example, when manufacturing a table. Other examples are a sawing aggregate, a drilling aggregate, a milling aggregate, a gluing aggregate and/or a welding aggregate.

In the case of FIG. 1, all aggregates 1 to 4 are assigned to different segments, namely segments S2, S4, S5 and S7. In other embodiments, a segment can also have two or more aggregates.

The first segment S1 has a conveyor belt section 10 which leads to the first machining aggregate 1. The second segment S2 has the first machining aggregate 1. The third segment S3 has a further conveyor belt section 20 which leads from the first machining aggregate 1 to the second machining aggregate 2. The fourth segment S4 has the second machining aggregate 2 as well a further conveyor belt section 30 which leads from the second machining aggregate 2 to the third machining aggregate 3. In other embodiments, the installation is, on the other hand, more finely divided such that each aggregate is assigned to its own segment. In other embodiments, several belt sections and/or one or more aggregates are, in turn, assigned to the same segment.

The fifth segment S5 has the third machining aggregate 3. The sixth segment S6 has a further conveyor belt section that leads from the third machining aggregate 3 to the fourth machining aggregate 4. The seventh segment S7 has the fourth machining aggregate 4. The eighth segment S8 lastly has a conveyor belt section 50 which leads downstream from the fourth machining aggregate 4 with respect to workpiece throughflow direction.

A high throughflow of workpieces takes place in the installation 100. In this embodiment, between 10000 and 12000 machined workpieces are transported per day on the belt section 50 during normal operation of the installation 100.

The installation 100 also further has a controller 101 which controls an operation of the installation 100. Among other things, this embodiment includes regulations of aggregates and conveyor belt sections. The controller 101 communicates wirelessly with aggregates and collects, for example, data information from sensors that are arranged in the aggregates.

Moreover, the installation 100 is equipped with special sensors which serve to perform the error detection method. For this, the installation was equipped with a sensor retrofitting set (not shown separately) which has sensors that are each suited to detecting a workpiece parameter or a plurality of workpiece parameters, as well as a data carrier (not shown) upon which a program is stored which is suited to be performed with the controller 101 so that the controller 101 together with the other components of the installation 100 can carry out the error detection method.

For this, sensors 11 are arranged above and below the conveyor belt section 10 in the first segment S1. In this embodiment, the sensors 11 each serve to detect a first distance d1 to the workpiece (from above the workpiece) and to detect a second distance d2 from the workpiece (from below the workpiece).

Furthermore, a sensor 12 is arranged in the first aggregate 1 (i.e. in the second segment S2). A sensor 21 is arranged at the belt section 20 in the third segment S3. A further sensor 22 is arranged at the belt section 30 in the fourth segment S4, directly downstream from the second aggregate 2. The fifth segment S5 has further sensors 31 and 32 in the third aggregate 3. Sensors 41 are also arranged above and below the conveyor belt section 40 in the sixth segment S6. The seventh segment S7 has a sensor 42 in the fourth aggregate 4, and a sensor 51 is also arranged in the eight segment S8 at the belt section 50.

All of the aforementioned additional sensors 11, 12, 21, 22, 31, 32, 41, 42 and 51 (“additional” to those sensors already in a conventional installation which are not formed to perform the error detection according to this disclosure) are suited to detecting a workpiece parameter. The workpiece parameter to be detected is thereby not the same for all of the sensors mentioned.

For example, the sensor 12 is formed to detect scraper blade swarf. For example, the sensor 51 detects a loose edge band. For example, the sensor 42 is formed to detect a reflectance of the workpiece. The sensor 32 is formed to detect a bore, and the sensor 31 is formed to detect a cupping (irregularity). Furthermore, the sensor 22 is formed to detect a groove, and the sensor 21 is formed to detect a cover layer projection.

The sensors 11 are suited to detecting a distance d1 from a sensor above the workpiece w to the workpiece and a distance d2 from a sensor below the workpiece w to the workpiece. The sensors 42 are also suitable for detecting a distance d1′ from the sensor above the workpiece w to the workpiece and a distance d2′ from the sensor below the workpiece w to the workpiece. Both the two (of the upper and the lower) sensors 11, as well as the two (of the upper and the lower) sensors 41 are formed as laser sensors.

In this embodiment, the upper sensors 11 and 41 each has a range of up to approximately 130 mm, and the lower sensors 11 and 41 each have a range of up to approximately 60 mm.

More generally, in these embodiments of an installation 100, the described sensors 11, 12, 21, 22, 31, 32, 41, 42 and 51 are each connected with corresponding units that are configured to transmit data via a wireless communication to the controller 101 which receives and continuously processes this data. In other embodiments, the communication is implemented via a cable connection. The controller 101 has a receiver which is suited to receive the wirelessly transmitted data.

The installation 100, and in particular the controller 101, are configured to perform a method for the detection of an error in the installation 100 and the local limitation of a cause of the error.

The method comprises the respective detection of the above-described workpiece parameters, with each of the sensors 11, 12, 21, 22, 31, 32, 41, 42 and 51 in the segments S1 to S8 of the installation 100.

The respective status information is transmitted to the controller 101, and in this embodiment, for each of the transmitted values of the respective status information it compares whether the value is beneath a lower threshold value or if it exceeds an upper threshold value.

Moreover, in this embodiment, a series of calculations are carried out on the basis of the distance values transmitted by the sensors 11 and 41. The distance between the respective upper sensor and the respective lower sensor is thereby known (or can be determined by a measurement). The distance between the two sensors 11 is called dsum, and the distance between the two sensors 11 is called dsum′.

Moreover, in this embodiment, also the length l and the width b of a workpiece is known (these are both significantly larger than the thickness d of the workpieces processed in the installation 100), and a diagonal γ of a side surface is calculated from these: γ=√l̅²̅+̅b̅²̅. In function of this diagonal, a dimension δ is defined for the tolerance as δ=0.2%·γ. Moreover, according to preferred embodiments, the tolerance is set in a range between 394 μm and 2 mm. If the above calculation establishes a smaller or a larger value, δ is set to 394 μm or 2 mm. These values are particularly suited to wood processing.

In each case the controller calculates as a method step the thickness d or d′ of a workpiece, as well as for the position of the sensors 11 as well as for the position of the sensors 41, as follows: d=dsum−(d1+d2) for the position of the sensors 11; and then d′=dsum′−(d1′+d2′) for the position of the sensors 41. Then it is determined in each case whether the thickness deviates by more than the tolerance value of a predetermined target thickness dsoll, i.e. it is checked whether d−dsoll>δ, and whether d′−dsoll′>δ. If one these inequalities is fulfilled, it is determined at the respective position of the sensors in the installation that the workpiece passing by is too thick. Furthermore, in this embodiment, it is checked whether the inequality dsoll−d>δ, and whether dsoll′−d′>δ is fulfilled. If one of these inequalities is fulfilled, the corresponding workpiece is too thin at the respective location in the installation. In the method according to the described embodiment, the corresponding workpiece is also automatically marked as faulty once it has been determined that it is too thin or too thick. For this, a corresponding marking element is provided which is controlled via a control process. In addition or alternatively, an error message can be output. In some embodiments, an error message is only then issued if a critical threshold percentage of faulty workpieces has been detected.

In this embodiment, the respective target values for the upper distance d1Soll and the lower distance d2Soll are also specified. It is then checked in each case whether the inequality d1Soll−d1>δ and/or whether d1Soll′−d1′>δ is fulfilled. If yes, the affected workpiece bends upwards (i.e. there is cupping). Furthermore, it is checked whether the inequality d1−d1Soll>δ or d1′−d1Soll′>δ is fulfilled. If yes, the affected workpiece bends downwards (i.e. there is cupping). It is also monitored whether the inequality d2Soll−d2>δ or d2Soll′−d2′>δ is fulfilled. If yes, the affected workpiece bends downwards (cupping). Furthermore, it is checked whether the inequality d2−d2Soll>δ or d2′−d2Soll′>δ is fulfilled. If yes, the affected workpiece bends upwards (cupping). If none of the inequalities is fulfilled, the workpiece (at least with respect to the absence of bending deformation) is to be categorized as “acceptable”.

Furthermore, it is also determined by means of the sensors 11 and 41 whether a workpiece is present between the respective upper and lower sensors. The presence of a workpiece is then concluded if the sum of the measured distances of the sensors is equal to or greater than the distance between the sensors.

The aforementioned errors are monitored by the controller 101, in particular, whether workpieces are too thin, too thick, bend downwards or upwards. A signal is thereby output with an error message if a predetermined threshold value is exceeded—for example, if an error is detected more often than a predetermined number of times in a day, or if a deviation from the tolerance value deviates by more than one threshold value. In the present embodiment, threshold values can be configured or changed by a user.

Furthermore, in this embodiment the controller 101 is configured to calculate trends. For example, it is therefore monitored whether an error rate increases. If the rate of workpieces that are too thin, too thick, bending upwards or bending downwards, for example, has increased by more than a predetermined threshold value, an error message is output. In this manner, an actual performance loss of the installation 100 (for example, a lower quantity of acceptable workpieces processed per day) can be prevented since gradual performance losses and/or tendencies can already be detected. Consequently, a part of the installation can be examined and/or maintained in time, for example, during a regular maintenance and/or downtime of the installation 100.

In more general terms, the controller determines whether there is an error depending on the detected and transmitted workpiece parameter data. An error is thereby not concluded alone from the presence of a deviation of a value from a target range, but rather threshold value can be set. For example, it can therefore be determined that an error is present at sensor 41, if during a longer time period, a too high percentage of workpieces with workpiece parameters deviating from target ranges has been detected.

In other words, the method comprises determining that there is an error, based on the workpiece parameters. The method also comprises, if there is an error, identifying in which of the at least two segments of the installation the error is, for local limitation of the cause of the error. This is carried out with this embodiment of the controller 101.

In the embodiment of FIG. 1, for example, a limitation of the cause of the error is carried out from the information at which sensor unusual values for the workpiece parameter have been determined. For example, in some embodiments, the fact that a sensor in segment S delivers different values leads to the conclusion that the error is in segment S. On the other hand, in other embodiments, and therefore also in the embodiment of FIG. 1, an error owing to a sensor in one segment can indicate the error source in a different installation segment. An example is the detection of a workpiece which bends downwards or upwards with the sensors 41 in segment S6. If it is simultaneously determined that in segments S1 to S4 there are “normal” (i.e. within corresponding target ranges) workpiece parameter values, the cause of the error is limited to segment S5, in this embodiment.

Furthermore, the method comprises outputting a signal that contains the information regarding which segment the error is (most likely) in. In the present embodiment, the signal is output by the controller 101 and displayed to the operating personnel of the system, for example, on a screen of a data processing system. In other embodiments, acoustic signals are output, for example, at certain positions in the installation. Alternatively or additionally, optical warnings can also be output. Thus, for example, a light can show that an error source is suspected in the third segment, etc.

In the method carried out in the installation according to the embodiment of FIG. 1, the identifying includes that the error is assigned to one specific aggregate or one specific part of the installation between two aggregates (in this case: a conveyor belt section), and the signal output from the controller 101 contains the information regarding which aggregate or which part of the installation between two aggregates is faulty.

In other words, in this embodiment, the error is assigned to one of the belt sections 10, 20, 30, 40, 50, or one of the aggregates 1, 2, 3, or 4. However, in other embodiments the local resolution of the error limitation is higher (thus, for example, an error can be assigned to one specific part of the aggregate or of a conveyor belt section) or alternatively, less precisely (thus, for example, an error is assigned to the part of the installation upstream from a specific point, etc.). The resolution of the error source allocation can also vary, depending on which type of error has been detected.

The invention also covers numerous modifications and modified embodiments.

What is claimed is:

1. A method for error detection and for local limitation of a cause of the error in an installation for machining a workpiece, the installation having several segments, comprising the steps:
detecting a workpiece parameter in at least two segments of the installation;
determining, on the basis of the detected workpiece parameter, whether there is an error with respect to the installation;
if there is an error, identifying which of the at least two segments of the installation the error is in, for local limitation of the cause of the error; and
outputting a signal that contains information regarding which segment the error is in.

2. The method of claim 1, wherein the workpiece is formed at least in sections from wood, a wood material, and/or a synthetic material.

3. The method of claim 1, wherein the determining whether there is an error comprises determining whether a future performance loss of the installation is to be expected, and wherein it is determined that there is an error if a future performance loss is expected.

4. The method according to claim 1, wherein the performance loss is defined as a falling beneath a predetermined threshold value of a quantity of workpieces processed by the installation during a predetermined time unit or as another parameter quantifying the performance of the installation.

5. The method according to claim 1, wherein the presence of an error is determined before the performance loss actually occurs.

6. The method according to claim 1, wherein the error is determined on the basis of a temporal development of a plurality of detected status information.

7. The method according to claim 1, wherein the installation has two or more aggregates for machining or inspecting workpieces and at least two aggregates are assigned to different segments.

8. The method according to claim 7, wherein the identification includes that the error is assigned to a specific aggregate or a specific part of the installation between two aggregates, and the output signal contains the information regarding which aggregate or which part of the installation between two aggregates is faulty.

9. The method according to claim 1, wherein at least one of the detected workpiece parameters is a distance from a sensor to a workpiece and/or a thickness, height, length, or width of the workpiece.

10. The method according to claim 1, wherein it is checked whether a workpiece has an undesired bend by measuring distances from one sensor or several sensors to at least two different positions of the workpiece, and for each of the measured distances it is determined whether the respective distance is below or above a lower or upper threshold value, or it is determined whether the sum of the distances or a different parameter which is a function of the distances is below or above a lower or upper threshold value.

11. The method according to claim 1, wherein it is checked whether the detected workpiece parameter or a parameter which is a function of the detected workpiece parameter or the detected workpiece parameters is within a predetermined tolerance range.

12. The method according to claim 1, wherein it is counted how often the same error occurs and it is determined whether the number of the same error exceeds a predetermined threshold value, and an error message is output if the threshold value is exceeded.

13. The method according to claim 1, wherein an error is recognized from a tendency of detected values of a workpiece parameter or from tendencies of a plurality of detected workpiece parameters.

14. The method according to claim 1, wherein at least one detected workpiece parameter is a number of conveyed workpieces, scraper blade swarf, loose edge band, cover layer projection, a cupping, a groove, a bore, a surface feature.

15. The use of the method according to claim 1 in an edging installation for machining an edge of a workpiece and/or for applying an edge element to a workpiece.

16. The use according to claim 15, wherein a diagonal of a surface of a workpiece is calculated or measured, and a tolerance value is set to a value in the range of 0.1% to 1% of the diagonal, and it being checked whether a thickness and/or a flatness of at least one part of a workpiece no longer deviates from a predetermined target value than by the tolerance value.

17. The use according to claim 16, wherein the diagonal is a largest diagonal of the largest surface of the workpiece, and wherein the tolerance value is set to a value between 300 μm and 2.5 mm.

18. A data carrier upon which a program is stored which is suited to be executed on a data processing system which can be operated together with an installation for machining a workpiece, so that the method is carried out according to claim 1.

19. Sensor equipment set for equipping an installation for machining a workpiece, with a sensor system for setting up the installation to perform a method for detecting an error and for local limitation of an error, the sensor system having a plurality of sensors suitable for the detection of a workpiece parameter, the sensor equipment set having a data carrier according to claim 18.

20. The sensor equipment set according to claim 19 comprising at least one sensor unit having at least one of the sensors, the sensor unit being configured to transmit a signal to a receiver via a cable connection or wirelessly.

21. An installation for machining a workpiece, the installation having several segments and each segment having at least one sensor for detecting a workpiece parameter characterized in that the installation further has a controller which is configured to carry out the method according to claim 1.

22. The installation according to claim 21 which is provided with a sensor equipment set for equipping an installation for machining a workpiece formed at least in sections from wood, a wood material, and/or a synthetic material, with a sensor system for setting up the installation to perform a method for detecting an error and for local limitation of an error, the sensor system having a plurality of sensors suitable for the detection of a workpiece parameter.
